(19) United States
(12) Patent Application Publication
(10) Pub. No.: US 2004/0047548 A1
(43) Pub. Date: Mar. 11, 2004

(54) Optical switching subsystem and optical switching subsystem self-diagnosing method

(75) Inventors: Toshiyuki Okumura, Tokyo (JP); Yoshiho Yanagita, Tokyo (JP); Shigeyuki Yanagimachi, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/614,055

(22) Filed: Jul. 8, 2003

(30) Foreign Application Priority Data
Jul. 9, 2002 (JP) 200442/2002

(51) Int. Cl. G02B 6/35

(52) U.S. Cl. 385/18

(57) ABSTRACT

An optical switching subsystem comprising; a plurality of input optical ports for inputting an optical signal, a plurality of output optical ports for outputting the optical signal, an optical switch formed by a micro electromechanical system (MEMS) for switching an optical path among said input optical ports and said output optical ports, a controller for instructing said optical switch to execute switching operation, and self-diagnosis means for measuring performance characteristics of said optical switching subsystem and diagnosing said optical switching subsystem based upon said performance characteristics.

### BACKGROUND OF THE INVENTION

1. Field of the Invention

The present invention relates to an optical switching subsystem that switches an optical path in an optical communication system such as an optical fiber communication network, particularly relates to an optical switching subsystem formed by a micro electromechanical system (MEMS).

2. Description of the Related Art

Recently, in an optical communication system represented by an optical fiber communication network, along with the increase in development of signal multiplexing technology, the need for an optical switch (an optical switching subsystem) that switches an optical path has increased.

For example, in an optical fiber communication network according to wavelength division multiplexing (WDM), after a multiplexed optical signal is selectively branched at each node on the network, a path is switched using an optical switch.

For the optical switch, multiple channels and a large scale are required to correspond the increase of transmission capacity estimated in future.

The optical switch includes mechanical one that switches an optical path based upon control over the angle of a reflecting mirror. This type of optical switch can make it possible to not only minimize delay time by switching but switch an optical path that does not depend upon transmission speed. Because it can switch the optical path without converting an optical signal to another type of signal such as an electric signal.

Particularly, as an optical switch formed by a MEMS utilizes the precise processing technology of a semiconductor integrated circuit in the manufacturing process, it is possible to downsize, integrate, array and enhance precision, and it is expected to fully correspond the increase of channels and the extension of a scale in future.

However, as the optical switch formed by a MEMS is provided with a mechanical movable part such as a hinge in the movable part of a reflecting mirror, it has a problem that it is influenced by the change of ambient temperature, the frequency of switching and the magnitude of the driven angle of the mirror and the angle of the reflecting mirror varies as time goes.

That is, in case the reflecting mirror formed by the MEMS is electrostatically driven, a precise mirror angle cannot be acquired because of aging even if appropriate voltage is applied to a mirror electrode.

In case aging is large even if feedback control based upon the detected light intensity of an output optical port is applied to the angle of the reflecting mirror, switching time is longer than normal switching time because of the deterioration of a response, and the performance and the reliability of an optical communication system may be deteriorated.

In addition, the optical switch described above, switching failure may be caused by the deterioration by aging of the movable part of the reflecting mirror. In case a host system continues the use of the optical switch without recognizing such a situation, the optical switch is suddenly disabled and the reliability of the optical communication system may be deteriorated.

To solve the problem, it is proposed a method of sending an optical signal to the optical switch after making a host system instruct an optical switch to make an operational check and checking the result.

However, in this case, there is a problem that as the load of the host system is increased, the performance of an optical communication system is deteriorated.

### BRIEF SUMMARY OF THE INVENTION

An object of the present invention is to provide an optical switching subsystem wherein the reliability of an optical communication system can be enhanced. Additional object of the present invention is to enhance a performance of the optical communication system.

According to a first aspect of the present invention, the optical switching subsystem comprising; a plurality of input optical ports for inputting an optical signal, a plurality of output optical ports for outputting the optical signal, an optical switch formed by a micro electromechanical system (MEMS) for switching an optical path among the input optical ports and the output optical ports, a controller for instructing the optical switch to execute switching operation, and self-diagnosis means for measuring performance characteristics of the optical switching subsystem and diagnosing said optical switching subsystem based upon the performance characteristics.

According to such configuration of the optical switching subsystem, the self-diagnosis of the performance characteristics of the optical switching subsystem is enabled.

Hereby, the reliability of the optical switching subsystem can be enhanced, the load of the host system is reduced and the performance of the optical communication system can be enhanced.

According to a second aspect of the present invention, the optical switching subsystem comprising; a plurality of input optical ports for inputting an optical signal, a plurality of output optical ports for outputting the optical signal, an optical switch formed by a MEMS for switching an optical path among said input optical ports and said output optical ports, a controller for instructing said optical switch to execute switching operation, and calibration means for calibrating control over the operation of said optical switch.

According to such configuration of the optical switching subsystem, the deterioration of a response due to the aging of the optical switch is improved and switching time can be reduced.

As calibration can be executed according to judgment on the side of the optical switching subsystem, the load of the host system is reduced and the performance of an optical communication system can be enhanced.

### BRIEF DESCRIPTION OF THE DRAWINGS

FIG. 1 is a block diagram showing the schematic configuration of an optical switching subsystem according to one embodiment of the present invention.

FIG. 2 is a block diagram showing the functional configuration of a subsystem controller according to one embodiment of the present invention.

FIG. 3 is a block diagram showing the functional configuration of a switching module controller according to one embodiment of the present invention.

FIG. 4 is a block diagram showing the configuration of a feedback control system according to one embodiment of the present invention.

FIG. 5 is a flow chart showing an operation of the optical switching subsystem according to one embodiment of the present invention.

FIG. 6 is a flowchart showing self-diagnosis operation (in switching) according to one embodiment of the present invention.

FIG. 7 is a flowchart showing an instruction for switching operation in a self-diagnosis operation according to one embodiment of the present invention.

FIG. 8 is a flowchart showing mirror driving in a switching mode in a self-diagnosis operation according to one embodiment of the present invention.

FIG. 9 is a flowchart showing a rank operation in a self-diagnosis operation according to the present invention.

FIG. 10 is a flowchart showing a self-diagnosis operation (when an optical signal is communicated) according to a second embodiment of the present invention.

FIG. 11 is a flowchart showing a rank operation in a self-diagnosis operation according to the present invention.

FIG. 12 is a block diagram showing the configuration of a feedback control system according to a third embodiment of the present invention.

FIG. 13 is a flowchart showing calibration operation (a controller output correction value) according to the third embodiment of the present invention.

FIG. 14 shows waveforms in the third embodiment of the present invention.

FIG. 15 is a flowchart showing a rank operation in the third embodiment of the present invention.

FIG. 16 shows waveforms in the third embodiment of the present invention.

FIG. 17 is a flowchart showing calibration operation (a controller output correction value) according to a fourth embodiment of the present invention.

FIG. 18 shows waveforms showing effect in the fourth embodiment of the present invention.

FIG. 19 is a block diagram showing the configuration of a feedback control system according to a fifth embodiment of the present invention.

FIG. 20 is a block diagram showing the configuration of an open loop control system according to the fifth embodiment of the present invention.

FIG. 21 is a flowchart showing calibration operation (correction gain) according to the fifth embodiment of the present invention.

FIG. 22 shows waveforms showing an exciting signal and a response of light intensity in the fifth embodiment of the present invention.

FIG. 23 shows waveforms showing the effect of the fifth embodiment of the present invention.

FIG. 24 shows waveforms showing a second example of the calibration operation (the correction gain) in the fifth embodiment of the present invention.

FIG. 25 shows waveforms showing a third example of the calibration operation (the correction gain) in the fifth embodiment of the present invention.

### DETAILED DESCRIPTION OF THE EXEMPLARY EMBODIMENTS

Referring to the drawings, embodiments of the invention will be described below.

[First Embodiment]

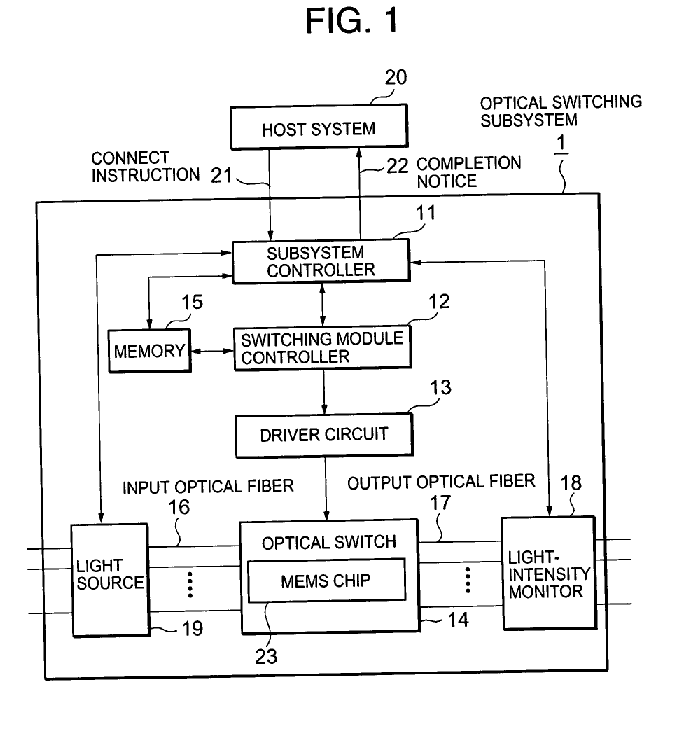

First, referring to FIG. 1, a first embodiment of the invention will be described.

FIG. 1 is a block diagram showing the schematic configuration of an optical switching subsystem according to the first embodiment of the present invention.

As shown in FIG. 1, the optical switching subsystem 1 is provided with a subsystem controller 11, a switching module controller 12, a driver circuit 13, an optical switch 14, a memory 15, an input optical fiber 16, an output optical fiber 17, a light-intensity monitor 18 and a light source 19.

The subsystem controller 11 has an interface with a host system 20 and controls the whole optical switching subsystem 1. The switching module controller 12 controls the driving of a mirror in the optical switch 14 according to an instruction from the subsystem controller 11. The driver circuit 13 amplifies control voltage for driving the mirror output from the switching module controller 12 up to the voltage required for the electrostatic actuation of the optical switch 14.

The optical switch 14 is formed by a micro electromechanical chip (an MEMS chip) 23. The optical switch 14 is provided with plural reflecting mirrors (not shown) operated at a predetermined angle by electrostatic actuation, plural input optical ports (not shown) to which plural input optical fibers 16 are connected and plural output optical ports (not shown) to which plural output optical fibers 17 are connected.

The optical switch 14 applies driving voltage input from the driver circuit 13 to an electrode of a predetermined reflecting mirror. At this time, the reflecting mirror is driven at a predetermined angle by electrostatic force and optically connects a predetermined input optical port and a predetermined output optical port. Optical connection between each port of the input optical fibers 16 and each port of the output optical fibers 17 can be arbitrarily switched by driving a predetermined mirror as described above in various patterns.

The memory 15 is connected to the subsystem controller 11 or the switching module controller 12 and stores control parameters related to mirror driving. The control parameters include, for example, a value of voltage required for connection between predetermined input/output ports in the optical switch 14 and applied to each reflecting mirror electrode, various parameters required for mirror driving including fine motion and coarse motion, a light intensity reference value and history data related to mirror driving up to the last occurrence.

The memory 15 may be also connected to both subsystem controller 11 and the switching module controller 12 and may be also formed by dual-port RAM that enables reading and writing data.

The light-intensity monitor 18 is provided with a tap coupler (not shown) and a photodiode (not shown). The tap coupler branches a part (for example, 10%) of output light from a specified port of the output optical fiber 17. The photodiode converts the branched output light to an electric signal and outputs an analog signal according to the light intensity of the output light in the output optical fiber 17.

The light source 19 is provided with a laser beam emitting diode (not shown) and a tap coupler (not shown). The laser beam emitting diode emits test light for testing and measuring the switching operation of the optical switch 14. The tap coupler inputs the test light to a specified port of the input optical fiber 16.

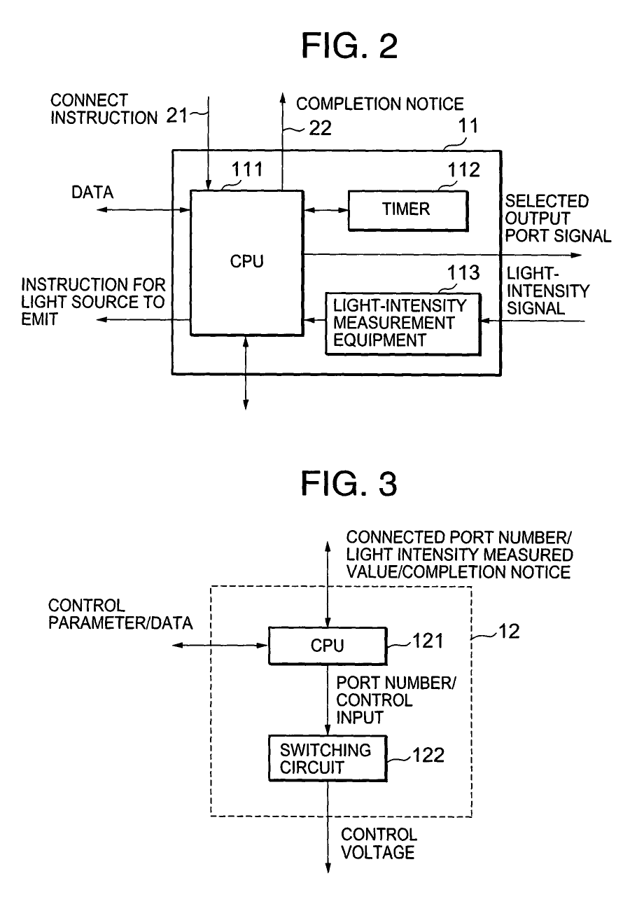

FIG. 2 is a block diagram showing the functional configuration of the subsystem controller in the first embodiment.

As shown in FIG. 2, the subsystem controller 11 is provided with CPU 111, a timer 112 and light-intensity measurement equipment 113.

The timer 112 counts time according to a command from CPU 111 and measures elapsed time. The light-intensity measurement equipment 113 receives the analog intensity signal from the specified port of the light-intensity monitor 18 according to a selected output port signal from CPU 111, digitizes it and supplies a digital intensity signal to CPU 111 as a light intensity measured value.

CPU 111 is provided with a function for communication with the host system 20 and the switching module controller 12.

The function for communication with the host system 20 includes a function for receiving a connect instruction 21 between predetermined ports from the host system 20 connected to an optical fiber communication network and a function for sending a connection completion notice 22 between predetermined ports to the host system 20.

The function for communication with the switching module controller 12 includes a function for outputting the connect instruction 21 to the switching module controller 12, a function for notifying the switching module controller 12 of the light intensity measured value from the light-intensity measurement equipment 113 and a function for reading connection result information from the switching module controller 12.

CPU 111 controls the whole optical switching subsystem 1. For example, it processes (acquires, compares, judges, and operates) data read from the memory 15, an emit command to be sent to the light source 19, data from the switching module controller 12, data from the light-intensity measurement equipment 113, the result of a count from the timer 112 and others and controls the whole optical switching subsystem 1.

FIG. 3 is a block diagram showing the functional configuration of the switching module controller 12 in the first embodiment.

As shown in FIG. 3, the switching module controller 12 is provided with CPU 121 and a switching circuit 122.

CPU 121 controls the driving of each reflecting mirror on the optical switch 14 according to the connect instruction 21 from the subsystem controller 11 and operates. Therefore, CPU 121 reads each parameter and data for sampling time at a fixed interval and outputs a control voltage which is the result of the processing to the driver circuit 13 via the switching circuit 122.

Besides, CPU 121 is also provided with a function for comparing and judging a light intensity reference value related to a predetermined reflecting mirror read from the memory 15 and a light intensity measured value read from the subsystem controller 11, and notifying the subsystem controller 11 of the result.

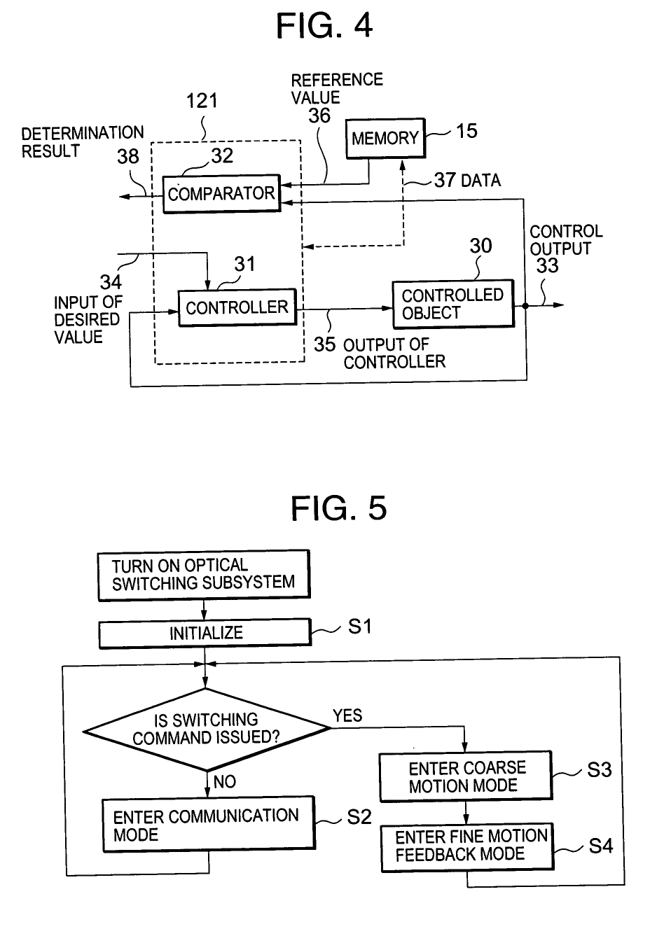

FIG. 4 is a block diagram showing the configuration of a feedback control system in the first embodiment.

As shown in FIG. 4, the feedback control system is provided with a controlled object 30, a controller 31 and a comparator 32.

The controlled object 30 is a part modeled after the reflecting mirror and controlled by CPU 121. The controlled object includes the switching circuit 122, the driver circuit 13, the optical switch 14, the light-intensity monitor 18, the light-intensity measurement equipment 113 and a part of the functions of CPU 111 for example, and is a part modeled to calculate a parameter of the controller 31.

The controlled object 30 receives the output 35 of the controller and outputs control output 33. For the control output 33 at this time, a light intensity measured value is used.

In case a two-dimensional position sensor for detecting the XY coordinates is used in place of the light-intensity measurement equipment 113, an XY coordinate value is used as control output.

In case an angle sensor for calculating the angle of the reflecting mirror based upon measured charge, the electrical resistance of a hinge and others is used, a mirror angle is used as control output.

The controller 31 is provided with a PID compensator and a state observer for example. For the controller 31, a linear or nonlinear controller such as a phase lead/lag compensator, an H infinity controller, a disturbance observer and a nonlinear gain controller can be used.

The controller 31 receives a control parameter and data 37 such as voltage (a preset value) applied to a predetermined reflecting mirror electrode provided to the optical switch 14, a variable to the controlled object 30 and a reference value (Iref) from the memory 15 at a sampling cycle.

The controller 31 receives the control output 33 and an input desired value 34 from the subsystem controller 11 at a sampling cycle. The controller 31 executes control and operation related to mirror driving based upon these and outputs as the output 35 of the controller.

The comparator 32 compares the control output 33 and the reference value (Iref) 36 read from the memory 15. The comparator 32 receives the control output 33 and the reference value 36 and outputs the result of determination result 38. In case light intensity is selected for the control output 33, a light intensity reference value is used for the reference value. In this embodiment, the control output 33 is sent to the comparator 32, however, control input 45, a controller output correction value 43 and conversion correction gain (described below) may be also input to the comparator 32.

Next, referring to FIG. 5, the operation of the optical switching subsystem 1 according to the first embodiment will be described.

FIG. 5 is a flowchart showing the operation of the optical switching subsystem according to the first embodiment.

As shown in FIG. 5, the optical switching subsystem 1 enters a control operation mode after initialization (S1 in FIG. 5).

In the control operation mode, after reflecting mirror control related one input optical port and an output optical port connected to it at a predetermined sampling interval, the controlled object is sequentially connected to the next input optical port.

The control operation mode includes two modes, a communication mode and a switching mode. The communication mode is feedback control (S2 in FIG. 5) including the setting of a control parameter for each reflecting mirror, the measurement of light intensity, operation control and the output of a driver for keeping light intensity required for optical communication between ports of the input/output optical fibers 16, 17 to be controlled.

In the switching mode, for connection between predetermined ports of the input/output optical fibers 16, 17, first, the state value of the reflecting mirrors except the switching reflecting mirror is held. Afterward, a coarse motion mode in which the angle of the reflecting mirror of the optical switch 14 is varied without passing light is started (S3 in FIG. 5). Afterward, a fine motion feedback mode in which the fine control of a mirror angle is made, for observing the intensity of light from the light source 19 (S4 in FIG. 5). In these continuous two types of modes, the angle of the reflecting mirror is varied.

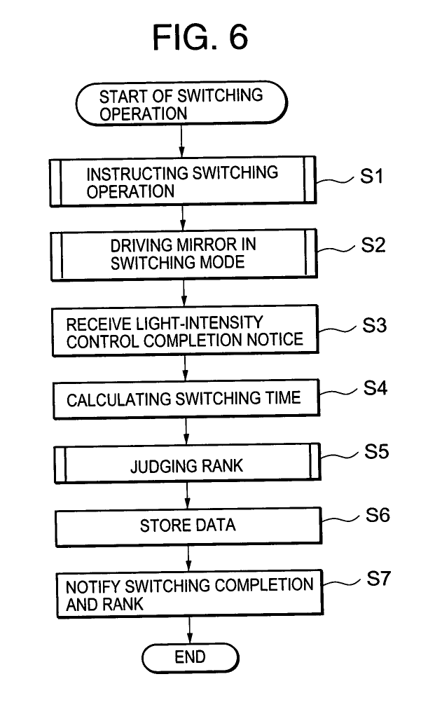

Next, referring to FIGS. 6 to 9, self-diagnosis operation (self-diagnosis means) in switching (in optical path switching by reflecting mirror driving) in the first embodiment will be described.

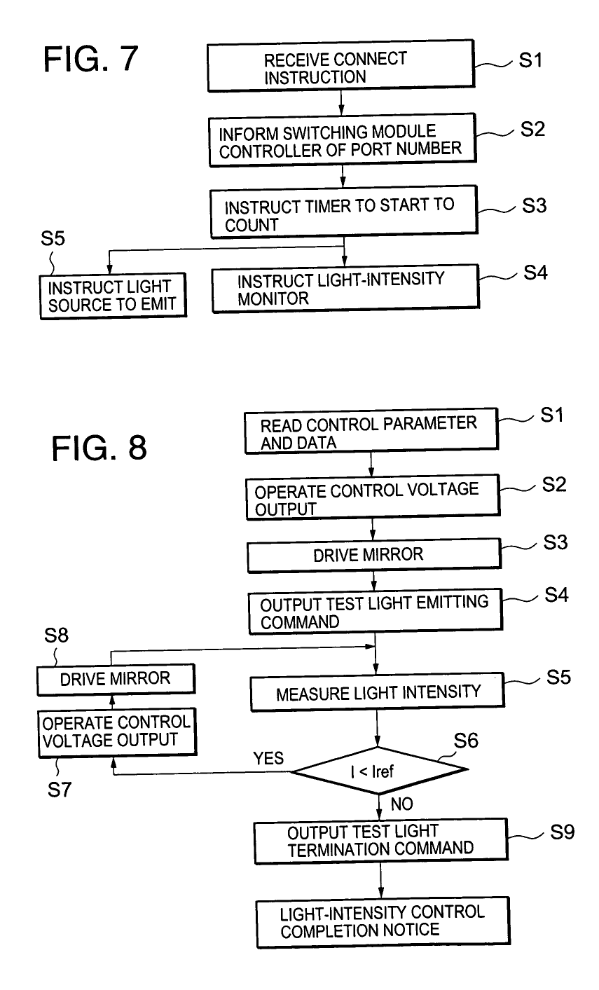

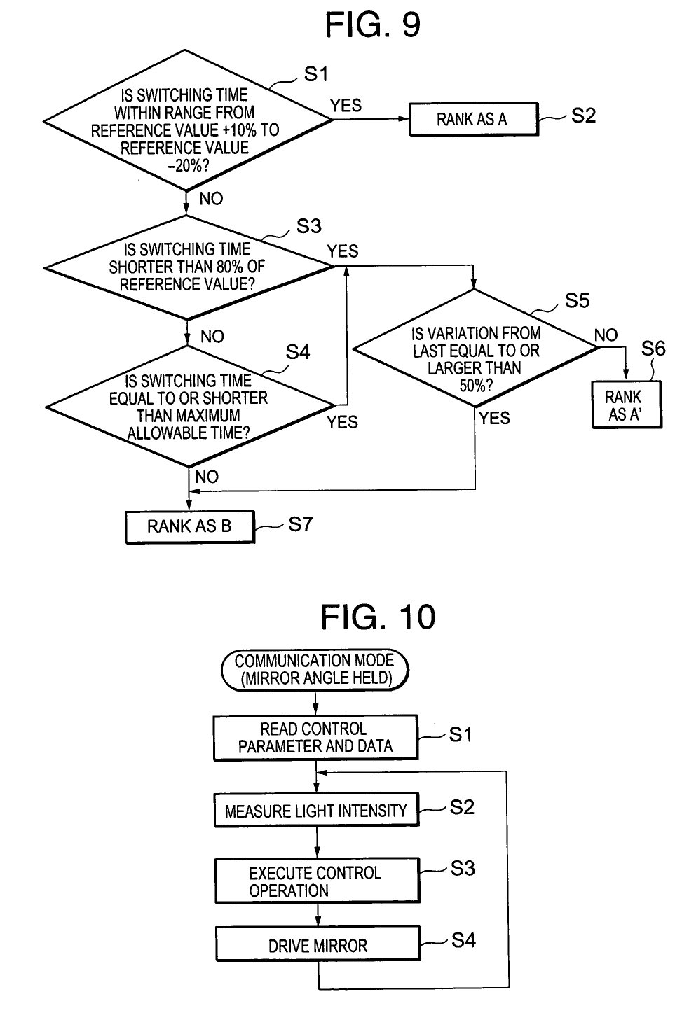

FIG. 6 is a flowchart showing self-diagnosis operation (in switching) in the first embodiment, FIG. 7 is a flowchart showing an instruction for switching operation in the self-diagnosis operation, FIG. 8 is a flowchart showing mirror driving in the switching mode in the self-diagnosis operation and FIG. 9 is a flowchart showing the judgment of rank in the self-diagnosis operation.

In switching, the connect instruction 21 between predetermined ports is obtained from the host system 20 to the subsystem controller 11. According to this instruction, the subsystem controller 11 executes operation shown in FIG. 6.

CPU 111 of the subsystem controller 11 instructs switching operation when CPU receives the connect instruction 21 (S1 in FIG. 6).

As shown in FIG. 7, when CPU receives the connect instruction (S1 in FIG. 7), it supplies the corresponding port number to the switching module controller 12 (S2 in FIG. 7) and instructs the timer 112 to start to count (S3 in FIG. 7).

Further, CPU instructs the light-intensity monitor 18 to select an output port and instructs the light-intensity measurement equipment 113 to output. Afterward, the light-intensity measurement equipment 113 starts the digitalization of a supplied light-intensity signal (S4 in FIG. 7). CPU also instructs the light source 19 to emit test light (S5 in FIG. 7).

Next, CPU instructs the switching module controller 12 to drive a predetermined mirror in the switching mode (S2 in FIG. 6).

As shown in FIG. 8, the switching module controller 12 executes the coarse motion mode and fine motion feedback control operation based upon light intensity.

CPU 121 of the switching module controller 12 reads data such as a preset value of control input to each mirror electrode required for connecting input predetermined ports, a variable to be sent to the controller and the light intensity reference value from the memory 15 (S1 in FIG. 8).

Afterward, CPU operates control voltage to be applied to a predetermined mirror electrode for acquiring a predetermined angle so that the reflecting mirror of the optical switch 14 connects predetermined ports and outputs it to the driver circuit 13 (S2 in FIG. 8).

The driver circuit 13 amplifies input control voltage, applies driving voltage to the predetermined mirror electrode and drives the reflecting mirror (S3 in FIG. 8). The coarse motion mode operation is executed in the steps S2 and S3.

After the coarse motion mode is completed, a test light emitting command is sent to the light source 19 as an output (S4 in FIG. 8). Afterward, a test light intensity signal is sent from the light-intensity monitor 18 connected to a predetermined output port to the light-intensity measurement equipment 113. The test light intensity signal is represented as a numerical value, is supplied to CPU 111 and simultaneously, is sent to the switching module controller 12 (S5 in FIG. 8).

The switching module controller 12 compares the light intensity reference value Iref read from the memory 15 and light intensity I measured in S5 (S6 in FIG. 8), in case the light intensity measured in S5 is smaller than the light intensity reference value Iref, the switching module controller operates the output of the controller, outputs control voltage (S7 in FIG. 8) and the driver circuit 13 drives a predetermined mirror (S8 in FIG. 8).

In the steps S5 to S8, fine motion feedback control based upon the light-intensity signal is executed to connect the predetermined ports.

In case light intensity I is equal to or exceeds the light intensity reference value Iref, a test light termination command is sent to the light source 19 as an output (S9 in FIG. 8) and the switching module controller 12 notifies the subsystem controller 11 of the completion (S10 in FIG. 8).

CPU 111 of the subsystem controller 11 that receives the notice of completion instructs the timer to stop count started in S1 and calculates elapsed time from S1 to time when the notice of completion is received (S4 in FIG. 6).

Next, a value for switching time is acquired by CPU 111 of the subsystem controller 11 as a reference for every connecting mirror beforehand or its maximum allowable value (for example, a reference value is 7 mS and the maximum allowable value is 10 mS). The values are compared and rank is determined.

The set reference value is different depending upon the number of switching elements (a scale) of the optical switch, the arrangement of driven reflecting mirrors and connected ports and is set in consideration of dispersion in manufacturing the MEMS mirrors. The maximum allowable value shall be a maximum value such that the host system 20 does not judge that the optical switching subsystem 1 is not good (S5 in FIG. 6).

For example, as shown in FIG. 9, in case the switching time is within a range from the reference value +10% to the reference value −20% (S1 in FIG. 9), the corresponding reflecting mirror is ranked as A (S2 in FIG. 9). In this case, it is judged that there is no problem in driving the reflecting mirror and the reflecting mirror is normally driven.

Next, in case the switching time is outside the range from the reference value +10% to the reference value −20% and is equal to or below 0.8 time of the reference value (S3 in FIG. 9) or is equal to or below the maximum allowable value (S4 in FIG. 9), the switching time is compared with switching time in last connection and in case the variation is within 50% (S5 in FIG. 9), the corresponding reflecting mirror is ranked as A′ (S6 in FIG. 9). In this ranking, the operation of the reflecting mirror is judged to be required to be watched though it has no problem in communication with the host system 20.

The reflecting mirrors except ones described above are ranked as B (S7 in FIG. 9) and are judged to be unavailable. The rank B indicates that the operation of the reflecting mirror is slow and is unstable.

Data acquired by the operation described above is stored in the memory 15 and is used for the material of judgment for ranking in next switching (S6 in FIG. 6).

Afterward, the subsystem controller 11 notifies the host system 20 of a switching termination notice and ranking information (in an unavailable case, information that switching operation is disabled) as the notice of completion 22 (S7 in FIG. 6).

Hereby, the self-diagnosis operation in switching in the optical switching subsystem 1 is completed.

The criterion of judgment and the number of ranks related to switching time are not limited to ones described above and may be varied depending upon the number, the arrangement, the characteristic and the driving condition of the mirrors of the optical switch.

For example, mirrors ranked as B are further classified based upon the driven angle and may be also classified based upon switching time at a small angle and at a large angle. For information sent to the host system 20, not only ranking but switching time itself may be also sent.

According to the first embodiment configured as described above, when the ports of the optical switch 14 are connected according to an instruction from the host system 20, switching time is measured in the optical switching subsystem 1. The reflecting mirrors are ranked by comparing the switching time with the reference value or the maximum allowable value and ranking is sent to the host system 20 together with a switching completion notice.

Hereby, not only binary information related to whether switching is possible or not but information related to a situation of switching operation are provided to the host system 20. The information can be used for the material of judgment related to the prediction of failure such as the problem and the inoperativeness of switching.

Therefore, sudden disconnection can be prevented by utilizing information related to a situation of the operation and the reliability of the optical switching subsystem and the optical communication system can be enhanced.

The host system 20 can find a connection port required to be watched based upon the information of ranking. As such a connection port can be classified into an auxiliary port, the resources can be effectively utilized by reconfiguration related to a fiber used in the host system 20 and the rearrangement of ports according to required communication quality.

Besides, as the host system can grasp the working situation of the optical switching subsystem, the host system can prevent communication failure by the problem of the optical switching subsystem. The failure can be predicted based upon not only binary judgment related to whether the optical switching subsystem can switch or not but the aging of the notified contents. Hereby, the reliability of the optical communication system can be enhanced.

[Second Embodiment]

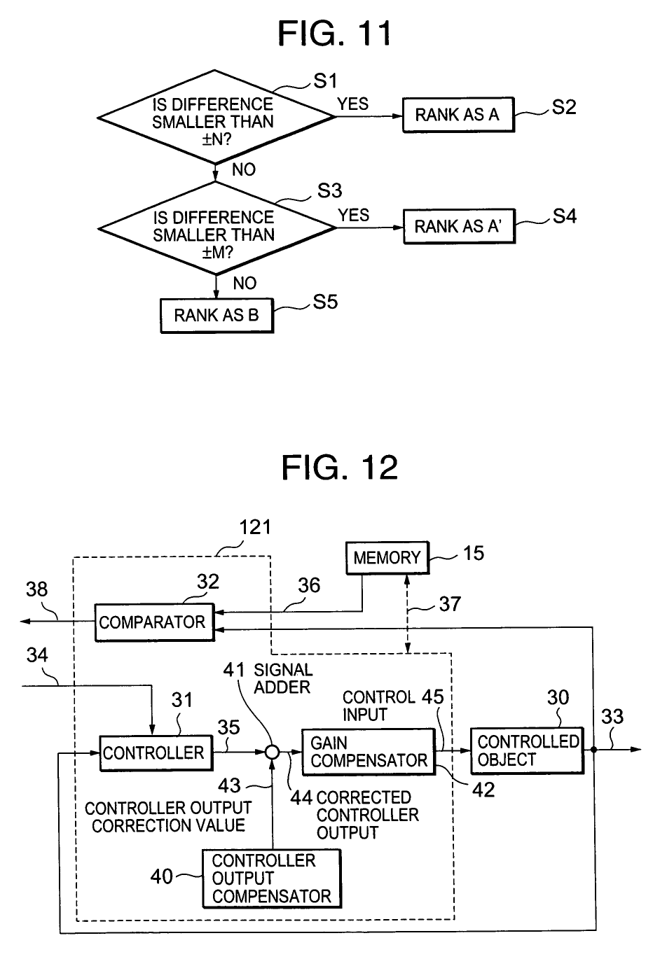

Next, referring to FIGS. 10 and 11, a second embodiment of the invention will be described. However, the same reference number is allocated to a common component to the first embodiment and the detailed description is omitted.

FIG. 10 is a flowchart showing self-diagnosis operation (when an optical signal is communicated) in the second embodiment and FIG. 11 is a flowchart showing the judgment of rank in the self-diagnosis operation.

An optical switching subsystem 1 equivalent to the second embodiment is substantially the same as that in the first embodiment in view of the structure. However, the optical switching subsystem in the second embodiment is different from that in the first embodiment in that self-diagnosis operation is executed when an optical signal is communicated (the angle of a reflecting mirror is held).

When an optical signal is communicated, the optical switching subsystem 1 keeps input/output ports in a connected state as described in the first embodiment. That is, feedback control is executed by a switching module controller 12 at a predetermined sampling cycle so that a reflecting mirror of an optical switch 14 is kept at a fixed angle.

As shown in FIG. 10, in communication in which predetermined ports are connected, the switching module controller 12 reads control parameters including data in last sampling from a memory 15 (S1 in FIG. 10). The switching module controller receives the data of light intensity measurement from a subsystem controller 11 (S2 in FIG. 10).

The switching module controller executes control operation based upon these values (S3 in FIG. 10), supplies control input to a driver circuit 13 and executes mirror driving (S4 in FIG. 10). Control parameters such as control input newly acquired in the control operation are stored in the memory 15 again and are used for control parameters in the next sampling.

The subsystem controller 11 compares (differentiates) a preset value of the output of a controller out of control parameters and the output of the controller newly acquired by control operation in this sampling as shown in FIG. 11.

In case the output of the controller in this sampling is the same as the preset value, the difference is zero. In case the difference is within ±N (S1 in FIG. 11), the corresponding reflecting mirror is ranked as A (S2 in FIG. 11). In this case, it is judged that there is no problem in the driving of the reflecting mirror and communication is normally made.

“N” described above denotes control input equivalent to the variation of a mirror angle in a range in which a light-intensity level is the same and is a numerical value that varies depending upon the diameter of a reflecting mirror, the arrangement of the reflecting mirror, the scale of the switch and the angle-voltage characteristic of a switching element.

In case the difference is ±N to ±M (M>N) (S3 in FIG. 11), the reflecting mirror is ranked as A′ (S4 in FIG. 11). In this rank, it is judged that the light intensity is deteriorated though the operation of the reflecting mirror has no problem in communication with a host system 20.

“M” described above denotes control input equivalent to the angle of the reflecting mirror the intensity of light reflected on which is deteriorated up to a level at which communication is allowed and is a numerical value that varies depending upon various conditions as in the case of the rank A.

In case the difference is equal to or exceeds ±M, the reflecting mirror is ranked as B (S5 in FIG. 11). In this rank, the deterioration of light intensity exceeds a controllable range and the reflecting mirror is judged as unusable because it has difficulty in communication.

Afterward, the result of the judgment described above is notified the host system 20.

In the above description, rank is judged based upon the difference between the output of the controller in this sampling and its preset value, however, the whole difference in past sampling or a part is stored in the memory 15 and the change of the stored difference may be also used for the criterion of judgment. The value “N” or “M” are not limited the value or parameters as described above.

According to the second embodiment described above, substantially the same effect as that in the first embodiment can be produced. In addition, the second embodiment has an advantage that the self-diagnosis of the optical switch 14 can be also executed when the angle of the reflecting mirror of the optical switch 14 is held (when an optical signal is communicated). As a result, communication failure by the problem of the optical switch can be prevented beforehand

and the reliability of the optical switching subsystem 1 and an optical communication system can be enhanced.

[Third Embodiment]

Next, referring to FIG. 12, a third embodiment of the invention will be described. However, the same reference number is allocated to configuration common to that in each embodiment and the detailed description is omitted.

FIG. 12 is a block diagram showing the configuration of a feedback control system equivalent to the third embodiment.

The structure of an optical switching subsystem 1 equivalent to the third embodiment is substantially the same as that in the previous embodiments. However, the optical switching subsystem to the third embodiment is different from those in the embodiments in that calibration operation related to the control of an optical switch 14 is executed and self-diagnosis operation is executed based upon a correction value (a control input preset value) to be calibrated output from a controller.

In the third embodiment, calibration is executed when the subsystem is activated, every predetermined time or after failure diagnosis, however, it is also the same in succeeding embodiments.

As shown in FIG. 12, the feedback control system is provided with a controlled object 30, a controller 31, a comparator 32, a controller output compensator 40, a signal adder 41 and a gain compensator 42.

The controller output compensator 40 operates a controller output correction value 43 (a preset value of control input to a predetermined reflecting mirror electrode) used for correcting the output 35 of the controller calculated by the controller 31.

The controller output correction value (the preset value) 43 is a value for correcting disturbance and quantity equivalent to modeling according to the angle of a reflecting mirror to improve transient characteristics and is calculated based upon the output 35 of the controller and the state value of the controller (not shown).

For example, in case the output 35 of the controller is not zero but a certain value is obtained for the output when a reflecting mirror is kept at a fixed angle, a value (a value at certain time, a fixed value of certain time, an averaged value of certain time, a maximum value of certain time, a minimum value of certain time and a half of the sum of the maximum value and the minimum value of certain time) calculated based upon the output 35 of the controller is used for the controller output correction value 43.

In case the controller 31 is formed by a PID controller, the controller output correction value (the preset value) 43 calculated based upon a value acquired by multiplying a constant by the state value of an integrator is used in place of the output 35 of the controller.

Further, in a phase lead/lag compensator, a value calculated based upon a value acquired by multiplying a constant by an inside state value of the compensator is used for the controller output correction value (the preset value) 43 in place of the output 35 of the controller.

In addition, a value acquired by multiplying a constant or a variable by the state value of the controller is used for the controller output correction value (the preset value) 43.

The signal adder 41 adds plural signals and calculates the corrected output of the controller 44. The output 35 of the controller and the controller output correction value (the preset value) 43 are input to the signal adder 41 and the signal adder outputs the corrected output of the controller 44.

The gain compensator 42 estimates a variation in case gain from control input 45 to control output 33 varies and corrects so that gain from the corrected output of the controller 44 to control output 33 is equal to a designed value.

For example, the gain compensator 42 is provided with correction gain as a variable. The correction gain is an exemplary variable which is 1 in case the gain of a designed model of a controlled object and the gain of an actual mirror are equal and is defined as a variable for correcting the output 35 of the controller in case the gain of the designed model of the controlled object and the gain of the actual mirror are different.

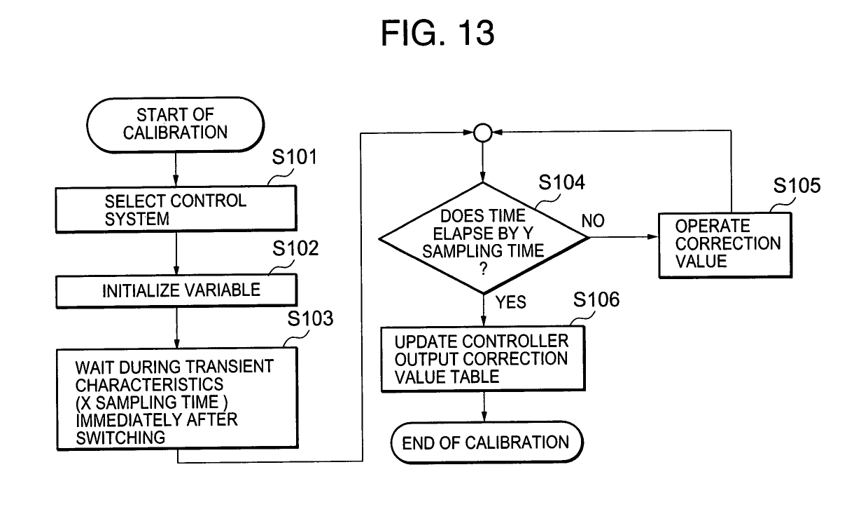

Next, referring to FIG. 13, calibration operation by a controller output correction value (a control input preset value) in the third embodiment will be described.

FIG. 13 is a flowchart showing calibration operation (the controller output correction value) in the third embodiment.

As shown in FIG. 13, in calibration operation by the controller output correction value, an start command is received and a control system is selected (S101 in FIG. 13). Next, a variable required to calculate the controller output correction value (the preset value) 43 is initialized (S102 in FIG. 13).

Next, the start of operating the correction value is awaited during X sampling time (X: arbitrary number) until transient characteristics by switching a control system come to an end (S103 in FIG. 13). When a wait from the transient characteristics come to an end is finished, it is determined whether time newly elapses by Y sampling time (Y: arbitrary number) or not (S104 in FIG. 13).

In case the wait time does not elapse by Y sampling time, operation for calculating the controller output correction value (the preset value) 43 such as averaging the output 35 of the controller is executed (S105 in FIG. 13) and control operation is continued.

After Y sampling time elapses, the controller output correction value (the preset value) 43 is ascertained and a controller output correction value table stored in the memory is updated (S106 in FIG. 13). The calibration operation is finished.

In the calibration operation shown in FIG. 13, the order of a step for selecting a control system (S101) and a step for initializing a variable (S102) may be also reversed. Besides, the order of the step for initializing a variable (S102) and a step for waiting until transient characteristics immediately after switching come to an end (S103) may be also reversed.

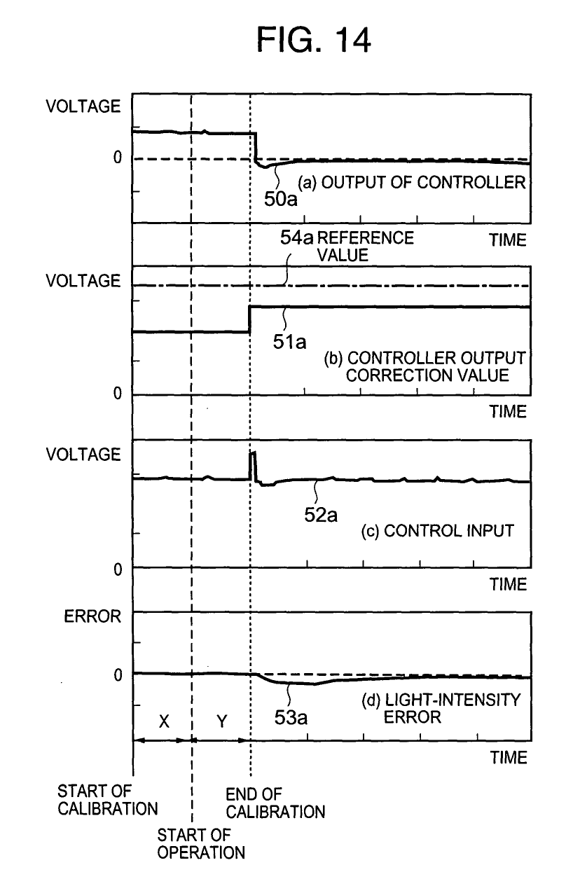

Next, referring to FIG. 14, calibration operation in case an optical fine motion feedback mode (light intensity is measured and a PID controller is used for the controller 31) is selected for a concrete example of the calibration operation will be described.

FIG. 14 shows a waveform showing action in the third embodiment.

As shown in FIG. 14, a response to the output 35 of the controller is shown as a controller output waveform 50a, a response to the controller output correction value (the preset value) 43 is shown as a controller output correction value waveform 51a, a response to control input 45 is shown as a control input waveform 52a, a response to a light-intensity error which is the difference between the input 34 of a desired value and control output 33 is shown as a light-intensity error waveform 53a and a value used for self-diagnosis is shown as a reference value 54a.

After switching to the optical fine motion feedback mode, processing is awaited by X sampling time until transient characteristics by switching a control system come to an end. Next, an updated value of the controller output correction value (the preset value) 43 is calculated so that a value of the controller output waveform 50a is zero for Y sampling time since the start of calibration.

After the calibration is finished, a value of the voltage correction value waveform 51a is updated and as a result, the control input waveform 52a varies. The controller output waveform 50a is also made to converge on zero by an optical fine motion feedback control system.

The light-intensity error generates transient characteristics in accordance with variation of the control input waveform 52a.

Next, the value updated by calibration of the controller output correction value (the preset value) 43 and the controller output correction value (the preset value) 43 before updating stored in the memory 15 are compared and ranking is executed.

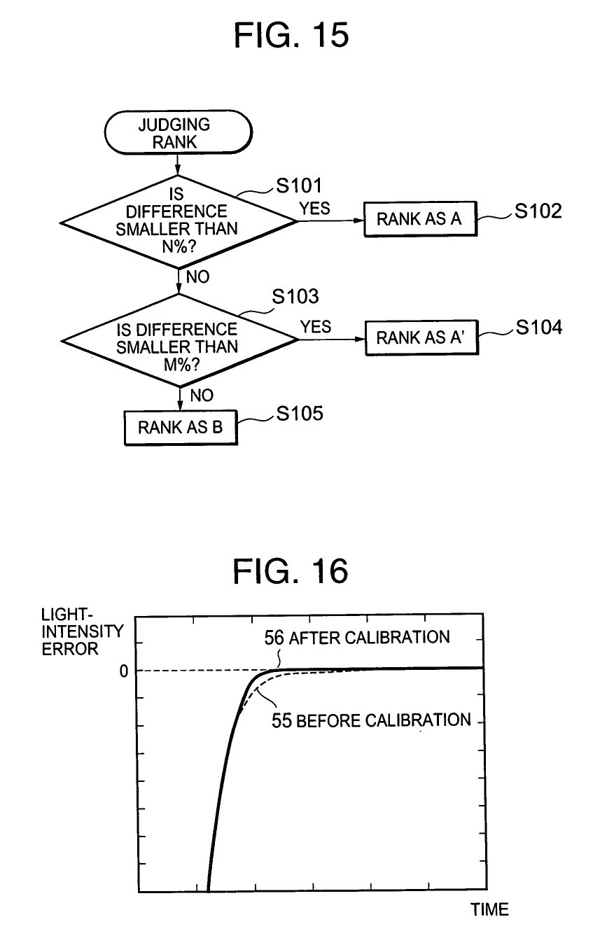

As shown in FIG. 15, in case the ratio of difference between the value after updating and the value before updating is within ±N% (S101 in FIG. 15), the corresponding reflecting mirror is ranked as A (S102 in FIG. 15). In this case, there is no problem in the angle of the reflecting mirror acquired in response to control input and it is judged that connection and communication between predetermined ports are normally made.

“N” described above denotes ratio (the ratio of the controller output correction value before updating to that after updating) equivalent to the variation of the angle of the reflecting mirror in a range in which a light-intensity level does not vary beyond fixed quantity and is a numerical value that varies depending upon the number and the arrangement of connection ports, a scale of the switch and the angle-voltage characteristics of a switching element.

In case the difference is ±N to ±M% (M>N) (S103 in FIG. 15), the corresponding reflecting mirror is ranked as A′ (S104 in FIG. 15). In this rank, there is no problem in connection and communication between predetermined ports, however, it is judged that control input for controlling so that the angle of the reflecting mirror is an angle for connection varies.

“M” described above denotes ratio (the ratio of the controller output correction value before updating to that after updating) equivalent to the variation of a mirror angle in a range in which communication is not hindered and is a numerical value that varies depending upon various conditions.

In case the difference is ±M% or more (S103 in FIG. 15), the corresponding reflecting mirror is ranked as B (S105 in FIG. 15). In this rank, the variation of the controller output correction value (the preset value) is large and even if allowable maximum voltage is applied, a reflecting mirror angle required for connection between predetermined ports is not acquired. Therefore, the corresponding reflecting mirror is judged as unusable because communication is difficult.

Afterward, the result of the judgment is notified the host system 20.

In the above description, rank is judged based upon the difference (the ratio) between controller output correction values before and after calibration, however, rank may be also judged based upon the whole difference in past calibration or a part is stored in the memory 15 and the change of the difference may be also used for the criterion of judgment.

According to the third embodiment described above, self-diagnosis is made by comparing the voltage correction value waveform 51a by calibration and the reference value 54a and ranking is enabled. The deterioration of a response due to an error of the controller output correction value is improved and switching time can be reduced. Hereby, communication failure by the problem of the optical switch 14 is prevented beforehand and the reliability of the optical switching subsystem 1 and an optical communication system can be enhanced. The deterioration of a response due to the aging of the optical switch is improved by calibration related to control over the operation of the optical switch and switching time can be reduced. In addition, as the calibration can be executed by judgment on the side of the subsystem, the load of the host system is reduced and the performance of the optical communication system can be enhanced.

Besides, as in the third embodiment, the calibration of the controller output correction value is made, transient characteristics in switching operation can be improved.

FIG. 16 shows the effect in case switching operation is started in certain input/output relation and another input/output relation is constructed for example. In FIG. 16, a response to a light-intensity error before calibration (in case the output 35 of the controller has a value except zero) is shown as a waveform 55 and a response to the light-intensity error after the calibration is shown as a waveform 56.

That is, in FIG. 16, the light-intensity error in switching operation is compared before and after calibration and FIG. 16 shows that the deterioration of the response due to an error between the controller output correction values is improved by calibration. Hereby, the reduction of switching time and the reduction within the designed time of switching time are enabled.

[Fourth Embodiment]

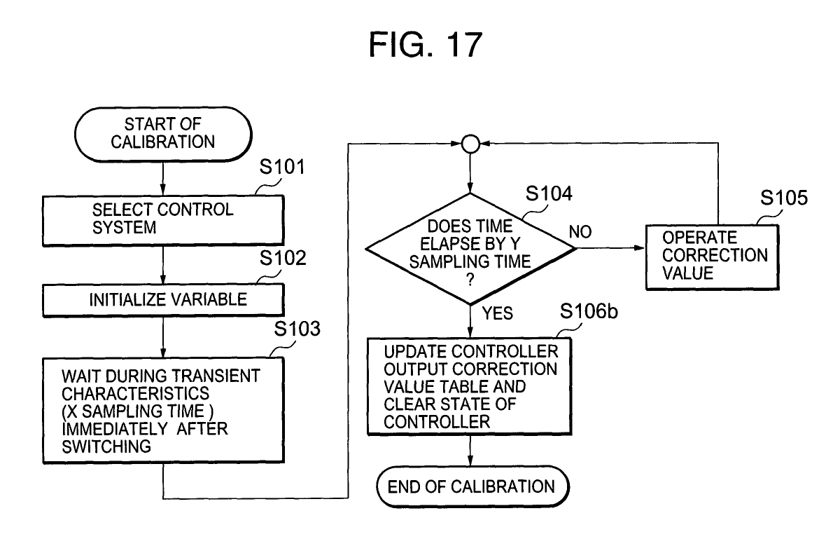

Next, referring to FIG. 17, a fourth embodiment of the invention will be described. However, the same reference number is allocated to configuration common to that in each embodiment described above and the detailed description is omitted.

FIG. 17 is a flowchart showing calibration operation (a controller output correction value) in the fourth embodiment.

In the fourth embodiment, the calibration of the controller output correction value is made using the same feedback control system as that in the third embodiment, however, the fourth embodiment is different from the third embodiment in the contents of calibration.

That is, in the third embodiment, after the controller output correction value table is updated, a response waveform may be disturbed by transient characteristics. In the meantime, in the fourth embodiment, at the same time as the controller output correction value table is updated, a part or the whole state value of a controller is reset (is set to zero) (S106b in FIG. 17). For example, in case a PID controller is used for the controller 31, the state value of integral control action is reset.

Also in the fourth embodiment, as in the third embodiment, a value updated by calibration of the controller output correction value (the preset value) 43 and the controller output correction value (the preset value) 43 before updating stored in the memory 15 are compared and ranking is executed.

According to the fourth embodiment described above, as in the third embodiment, self-diagnosis is made by comparing a voltage correction value waveform 51b by calibration and a reference value 54b and ranking is enabled. Hereby, communication failure by the problem of an optical switch 14 is prevented beforehand and the reliability of an optical switching subsystem 1 and an optical communication system can be enhanced.

Besides, in the fourth embodiment, as in the third embodiment, as the controller output correction value is calibrated, transient characteristics in switching operation can be improved.

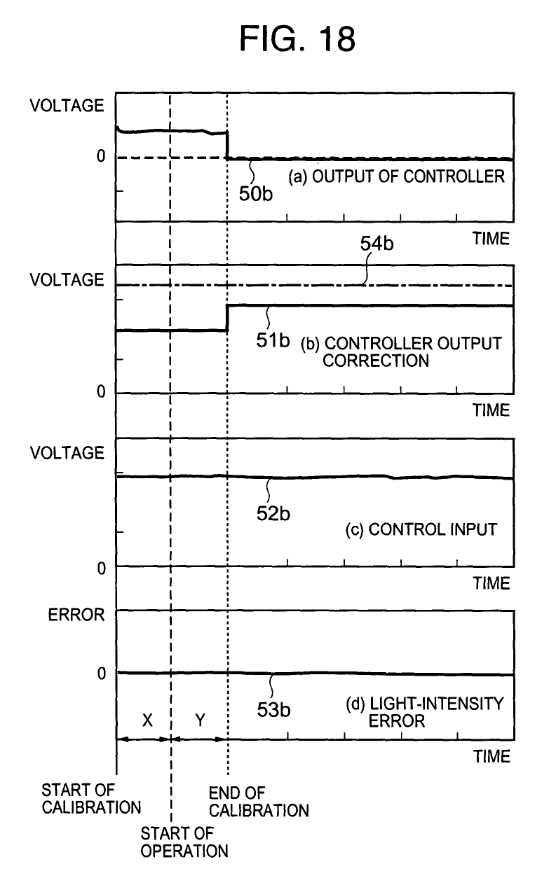

Further, in the fourth embodiment, as the state value of an integrator is reset, the disturbance of the controller output waveform 50b, the control input waveform 52b and the light-intensity error 53b by transient characteristics in the third embodiment in case a value of the voltage correction value 51b in the table is updated when calibration is finished can be improved (see FIG. 18).

[Fifth Embodiment]

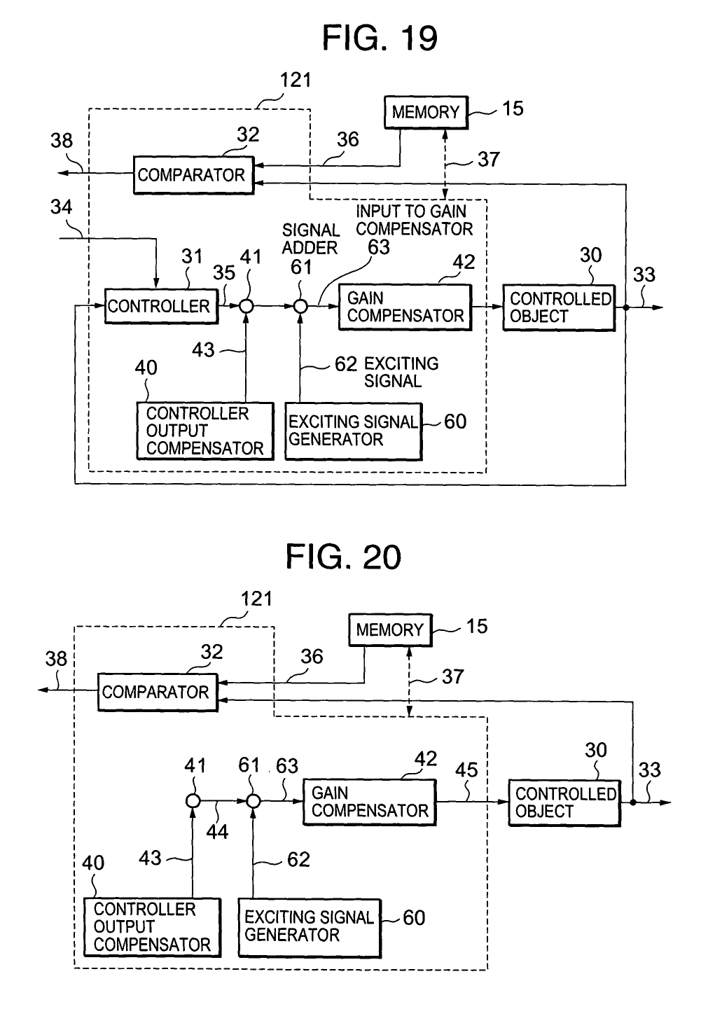

Next, referring to FIG. 19, a fifth embodiment of the invention will be described. However, the same reference number is allocated to configuration common to that in each embodiment described above and the detailed description is omitted.

FIG. 19 is a block diagram showing the configuration of a feedback control system equivalent to the fifth embodiment.

The fifth embodiment is different from the embodiments described above in the configuration of the control system and a calibrated object (conversion correction gain between control input input to an optical switch and the control output of the optical switch).

The feedback control system equivalent to the fifth embodiment is provided with a controlled object 30, a controller 31, a comparator 32, a controller output correction value 40, signal adders 41, 61, a gain compensator 42 and an signal generator 60.

The signal generator 60 generates a signal applied to control input to calculate the correction gain of the gain compensator 42. The signal generator 60 outputs an exciting signal 62. The exciting signal 62 includes a sine wave of a single frequency, a signal in which plural sine waves are superimposed, a step signal, a ramp signal, white noise and a signal the specific frequency of which is stressed by filtering white noise and is a signal for intentionally changing the control output 33.

The signal adder 61 adds plural signals and calculates input 63 to the gain compensator. The signal adder 61 receives the output 35 of the controller and a voltage correction value 43 and outputs the input 63 to the gain compensator.

In the fifth embodiment, an open loop control system shown in FIG. 20 may be also used. The open loop control system shown in FIG. 20 is provided with a controlled object 30, a comparator 32, a controller output compensator 40, signal adders 41, 61, a gain compensator 42 and an signal generator 60.

The controller output correction value 43 fixes a mirror angle and an exciting signal 62 varies control output 33.

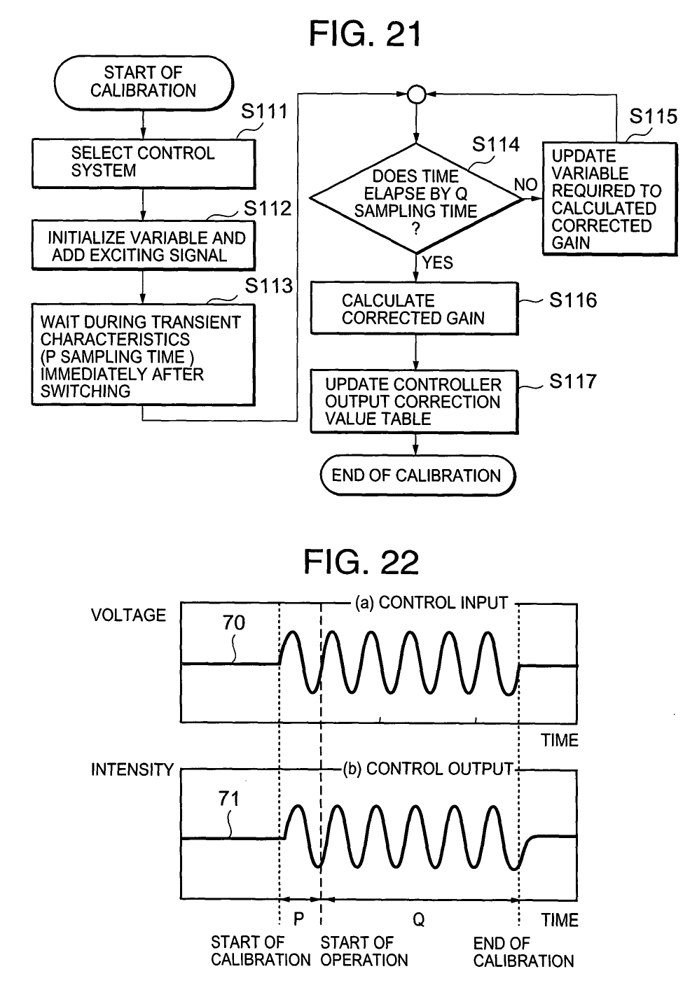

Next, referring to FIG. 21, the calibration operation of correction gain in the fifth embodiment will be described.

FIG. 21 is a flowchart showing the calibration operation (the correction gain) in the fifth embodiment.

As shown in FIG. 21, in the calibration operation of correction gain, an start command is received and a control system is selected (S111 in FIG. 21). A calibration control system includes the feedback control system shown in FIG. 19 and the open loop control system shown in FIG. 20.

Next, to calculate correction gain, the exciting signal 62 is applied to the corrected output 44 of the controller (S112 in FIG. 21). Next, the start of the operation of a correction value is awaited for P sampling time (P: arbitrary number) until transient characteristics by switching the control system and applying the exciting signal 62 come to an end (S13 in FIG. 21).

After the transient characteristics come to an end, it is determined whether time newly elapses by Q sampling time (Q: arbitrary number) or not (S114 in FIG. 21). In case time does not elapse by Q sampling time, a variable required to calculate correction gain such as averaging the output of the controller is updated (S115 in FIG. 21) and control operation is continued.

After time elapses by Q sampling time, correction gain is ascertained and a correction gain table stored in the memory 15 is updated (S116 in FIG. 21). Further, the variation of the correction gain of the gain compensator 42 is added to the controller output correction value 43 and a controller output correction value table is updated (S117 in FIG. 21). The calibration operation is finished.

Next, for a concrete example of the calibration operation, calibration operation in case the open loop control system shown in FIG. 20 is selected and a sine wave of a single frequency is applied as an exciting signal will be described, referring to FIG. 22.

FIG. 22 shows an exciting signal and a response waveform of light intensity in the fifth embodiment.

When calibration is started, an exciting signal is applied and processing is awaited by P sampling time. Next, a variable for calculating correction gain is updated. In this example, for a variable for calculation, the amplitude of driving voltage and the amplitude of light intensity are used. As the ratio of the amplitudes is equivalent to the gain of a controlled object at an exciting frequency of the exciting signal, the gain of an actual mirror can be calculated.

Further, the calculated ratio of the amplitudes and the ratio of gains used in a designed model are defined as correction gain. For example, in case the gain of the designed model at the exciting frequency is G1 and the calculated ratio of amplitudes is G2, correction gain is acquired by dividing G1 by G2 and control input 45 is acquired by multiplying input 63 to the gain compensator by G1/G2 in the gain compensator 42.

Or control input 45 is obtained by adding correction gain which is acquired by calculating (G1/G2−1) and a value which is acquired by multiplying input 63 to the gain compensator by (G1/G2−1) in the gain compensator.

In the above description, the sine wave of the single frequency is used for the exciting signal, however, a signal acquired by superimposing exciting signals, a step signal and a signal that varies control output such as a rectangular wave and a chopping wave may be also used.

Next, as in the case of the calibration of a controller output correction value, a value updated by the calibration of correction gain and correction gain before updating stored in the memory 15 are compared and ranking is executed. A used ranking routine is the same as that used in the third embodiment (see FIG. 15).

In case difference between updated correction gain and correction gain before updating is within ±N%, the corresponding reflecting mirror is ranked as A. In this case, the variation of applied voltage-reflecting mirror angle conversion gain is small, predetermined ports are connected and it is judged that communication is normally made.

“N” described above denotes ratio (the ratio of correction gains before and after updating) equivalent to the variation of a mirror angle in a range in which a light-intensity level does not vary beyond fixed quantity and is a numerical value that varies depending upon the number and the arrangement of connection ports, a scale of the switch and the characteristic of a switching element.

In case the difference described above is ±N to ±M% (M>N), the corresponding reflecting mirror is ranked as A′. In this rank, there is no problem in the connection of predetermined ports and communication, however, it is judged that applied voltage-reflecting mirror angle conversion gain varies.

“M” described above denotes ratio (the ratio of correction gains before and after updating) equivalent to the variation of a mirror angle in a range in which communication is not hindered and is a numerical value that varies depending upon various conditions.

In case the difference described above is ±M% or more, the corresponding reflecting mirror is ranked as B. In this rank, the variation of correction gain is large and a reflecting mirror angle required for connecting predetermined ports is not acquired even if maximum voltage is applied. Therefore, the corresponding reflecting mirror is judged as unusable because communication is difficult.

Afterward, the result of the judgment is notified the host system 20.

As described above, rank is judged based upon the ratio of correction gains before and after calibration, however, all or a part of difference in past calibration is stored in the memory 15 and the transition of the difference may be also used for the criterion of judgment.

According to the fifth embodiment described above, self-diagnosis is executed based upon a value of correction gain to be calibrated and ranking is enabled. Hereby, communication failure by the malfunction of the optical switch 14 is prevented beforehand and the reliability of the optical switching subsystem 1 and the optical communication system can be enhanced.

Besides, in the fifth embodiment, as correction gain is calibrated, transient characteristics in switching operation can be improved.

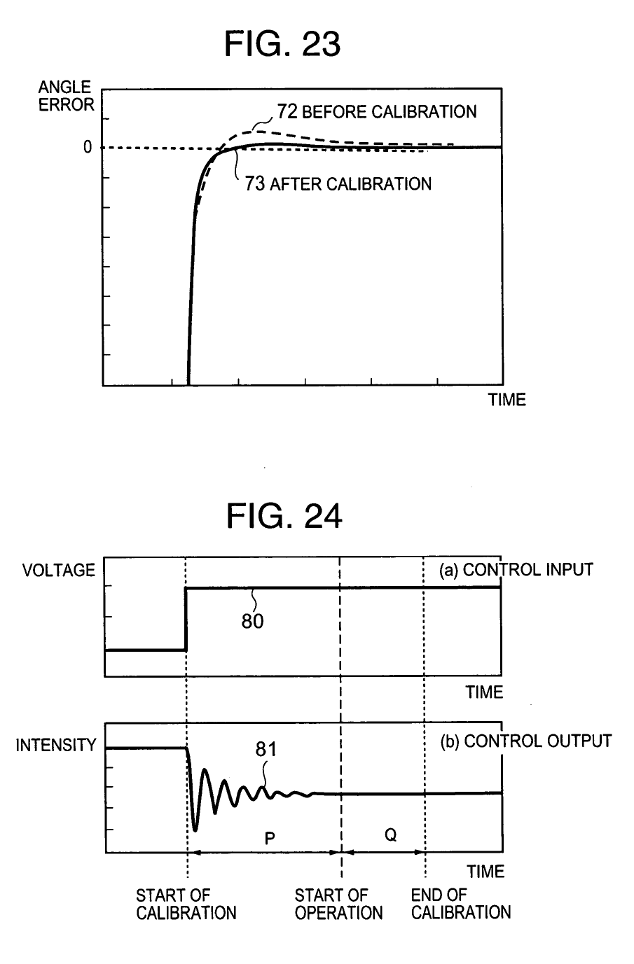

As shown in FIG. 23, when the gain of a reflecting mirror is off the designed model of a controlled object (increases by 10%) for example, overshoot shown by a response waveform 72 is caused and fixed settling time is required.

In the meantime, in case correction gain is updated by calibration, overshoot is inhibited as shown by a response waveform 73 and settling time can be reduced.

In the fifth embodiment, the following calibration operation may be also executed and will be described below as a second example of the fifth embodiment.

FIG. 24 shows waveforms in the second example of the calibration operation (correction gain) in the fifth embodiment.

In this example, the open loop control system shown in FIG. 21 is selected, input the constant value of which is fixed is applied as the exciting signal 62 to offset control output 33 and correction gain is calculated based upon the constant value of the exciting signal 62 and the constant value of the control output.

As shown in FIG. 24, step input is applied as the exciting signal 62 and a control input waveform 80 is applied to the controlled object 30. A reflecting mirror is driven by this input and a response of a control output waveform 81 is acquired.

The gain of a controlled object is calculated based upon the ratio by using the mean value of control input and the mean value of control output for a variable for calculating correction gain.

In the second example, as in the first example, a value of correction gain updated by calibration and correction gain before updating stored in the memory 15 are also compared and ranking is executed.

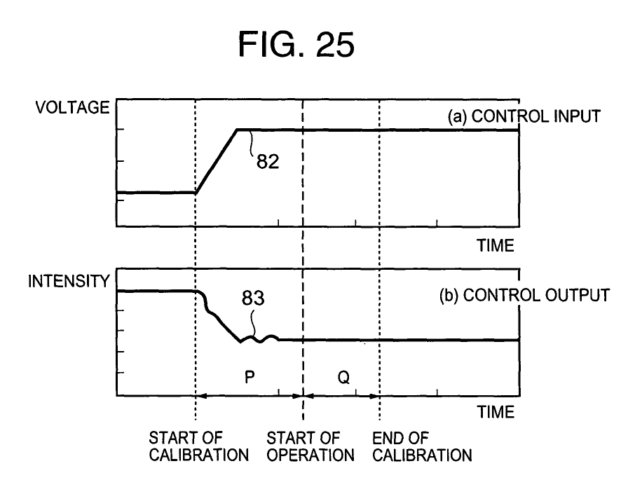

FIG. 25 shows waveforms in a third example of calibration operation (correction gain) in the fifth embodiment.

In this example, to reduce calibration time, a signal which varies up to a constant value like a ramp is used for the exciting signal 62 and a control input waveform 82 is input to a controlled object 30. A reflecting mirror is driven by this input and a response of a control output waveform 83 is acquired. The gain of a controlled object is calculated based upon the ratio by using the mean value of control input and the mean value of control output for a variable for calculating correction gain.

According to this example, in addition to the similar effect to that in the first example, as transient characteristics are improved as shown in FIG. 25, time required for calibration operation can be reduced.

The invention is not limited to the embodiments described above. For example, when failure is found by self-diagnosis, calibration is executed, afterward, self-diagnosis is executed again and when failure is found again, it may be also notified the host system 20. In this case, it can be expected that the cause of the failure is removed by the calibration and in case the cause of the failure is removed by the calibration, notice to the host system can be avoided.

In the embodiments described above, in switching and when an optical signal is communicated, the self-diagnosis of performance characteristics is executed without an instruction from the host system, however, when an instruction from the host system is received, self-diagnosis may be also made.

In the embodiments described above, calibration is executed when the optical switching subsystem is activated and every predetermined time without an instruction from the host system, however, when an instruction from the host system is received, calibration may be also executed.

In case a control input value input to the optical switch is self-diagnosed, an inside state value of the controller used for calculating a control input value may be also self-diagnosed without self-diagnosing the control input value itself.

For example, the state variable includes a mirror angle and mirror angular velocity estimated by an observer (a controlled object mathematical expression model) for estimating control output inside the controller and the state value of an integrator in a PID controller.

In case conversion correction gain between control input to the optical switch and the control output of the optical switch is calibrated, a mirror angle, the XY coordinate values and a light-intensity measured value can be used for control output.

What is claimed is:

1. An optical switching subsystem comprising:
a plurality of input optical ports for inputting an optical signal;
a plurality of output optical ports for outputting the optical signal;
an optical switch formed by a micro electromechanical system (MEMS) for switching an optical path among said input optical ports and said output optical ports;
a controller for instructing said optical switch to execute switching operation; and
self-diagnosis means for measuring performance characteristics of said optical switching subsystem and diagnosing said optical switching subsystem based upon said performance characteristics.

2. The optical switching subsystem according to claim 1, wherein said performance characteristics are switching time of the optical path.

3. The optical switching subsystem according to claim 1, wherein said performance characteristics are control input value for inputting to said optical switch or a state variable of said controller used for calculating said control input value.

4. The optical switching subsystem according to claims 1, wherein said self-diagnosis means notifies a host system of a result of self-diagnosis.

5. The optical switching subsystem according to claim 1, wherein said self-diagnosis means ranks said performance characteristics and notifies a host system of ranking information.

6. The optical switching subsystem according to claim 1, wherein said self-diagnosis means is operated without an instruction from a host system.

7. An optical switching subsystem comprising:
a plurality of input optical ports for inputting an optical signal;
a plurality of output optical ports for outputting the optical signal;
an optical switch formed by a micro electromechanical system (MEMS) for switching an optical path among said input optical ports and said output optical ports;
a controller for instructing said optical switch to execute switching operation; and
calibration means for calibrating control over the operation of said optical switch.

8. The optical switching subsystem according to claim 7, said calibration means comprises compensating means for calculating a controller output correction value.

9. The optical switching subsystem according to claim 7, wherein said calibration means comprises gain compensating means for compensating converting correction gain between control input and control output of the optical switch.

10. The optical switching subsystem according to claim 7,
said calibration means is executed when the optical switching subsystem is activated and every predetermined time without an instruction from a host system.

11. An optical switching subsystem comprising:
a plurality of input optical ports for inputting an optical signal;
a plurality of output optical ports for outputting the optical signal;
an optical switch formed by a micro electromechanical system (MEMS) for switching an optical path among said input optical ports and said output optical ports;
a controller for instructing said optical switch to execute switching operation;
self-diagnosis means for measuring performance characteristics of said optical switching subsystem and diagnosing said optical switching subsystem based upon said performance characteristics; and
calibration means for calibrating control over the operation of said optical switch.

12. The optical switching subsystem according to claim 11, wherein said calibration means comprises compensating means for calculating a controller output correction value and said self-diagnosis means operates based upon said controller output correction value.

13. The optical switching subsystem according to claim 11, wherein said calibration means comprises gain compensating means for compensating converting correction gain between control input and control output of the optical switch and said self-diagnosis means operates based upon said converting correction gain.

14. The optical switching subsystem according to claim 11,
wherein the calibration means operates when the self-diagnosis means determines that a corresponding reflecting mirror of the optical switch fails based on measured performed characteristics.

15. The optical switching subsystem according to claim 14, wherein the self-diagnosis means operates again after the calibration is executed by the calibration means, and
the self diagnosis means notifies a host system when it is diagnosed at that time that the corresponding reflecting mirror fails.

16. An optical switching subsystem comprising:
a plurality of input optical ports for inputting an optical signal;
a plurality of output optical ports for outputting the optical signal;
an optical switch formed by a micro electromechanical system (MEMS) for switching an optical path among said input optical ports and said output optical ports;
a subsystem controller circuit for controlling said optical switching subsystem;
a switching module controller circuit for controlling said optical switch;
a memory connected to said subsystem controller and said switching module controller, for storing control parameters related to said optical switch;
a monitor for outputting a signal to the subsystem controller according to said output signal.

17. An optical communication system comprising:
said optical switching subsystem according to claim 16, a host system said host system recurring information related said optical switch from said optical switching subsystem.

18. The optical switching subsystem according to claim 16, comprising a ranking circuit for determining ranks of operation of switching elements.

19. The optical switching subsystem according to claim 16,
comprising a feedback control circuit for feedback controlling.

20. The optical switching subsystem according to claim 19,
wherein said feedback control circuit includes said memory, a controlled object for outputting control output, a controller for outputting output of controller to said controlled object, and a comparator for comparing said control output with reference value from said memory.

21. The optical switching subsystem according to claim 20,
wherein said feedback control circuit further includes a controller output compensator for outputting controller output correction value, a signal adder for adding the output of controller and the controller output correction value, and a gain compensator for outputting control input to said controlled object.

22. An optical switching subsystem self-diagnosing method comprising:
monitoring an intensity of an optical signal in an output optical port;
calculating a control voltage for controlling an optical switch according to at least said intensity of said optical signal;
controlling a mirror of the optical switch;
determining ranks of operation of plural mirrors in said optical switch.

23. The optical switching subsystem self-diagnosing method according to claim 22, further comprising
reading data for calculating said control voltage and
storing data acquired said operation of said optical switch.

24. The optical switching subsystem self-diagnosing method according to claim 22, further comprising
notifying a host system of information related to said ranks.

25. The optical switching subsystem self-diagnosing method according to claim 22, further comprising
compensating said control voltage.
